(19) United States
(12) Patent Application Publication
(10) Pub. No.: US 2025/0384468 A1
(43) Pub. Date: Dec. 18, 2025

(54) Advertisement Request Allocation Platform and Method of Determining an Optimum Offer Rate

(71) Applicant: LoopMe, Ltd., London (GB)

(72) Inventors: Leonard Newnham, Calvert (GB); Thomas Hunter Smith, London (GB)

(73) Assignee: LoopMe, Ltd., London (GB)

(21) Appl. No.: 18/945,774

(22) Filed: Nov. 13, 2024

(30) Foreign Application Priority Data
Jun. 12, 2024 (EP) EP24181767
Jun. 13, 2024 (GB) 2408473.3

(51) Int. Cl. G06Q 30/0273; G06Q 30/0251

(52) U.S. Cl. CPC G06Q 30/0275; G06Q 30/0264

(57) ABSTRACT

An advertisement request allocation platform includes: a monitoring module comprising an offer rate builder, the offer rate builder configured to periodically determine a utilization rate using a plurality of candidate time windows, wherein the utilization rate for a combination of a group of advertisement requests and a demand-side platform (DSP) comprises a rate at which the DSP utilizes the group, the offer rate builder further configured to periodically determine for the combination a measure of variability of the utilization rate; and an offer module operably connected to the DSP; and an offer module configured to offer an advertisement request to the DSP, wherein the offer module is further configured to adapt a rate at which advertisement request is offered to the DSP based on the utilization rate for the DSP.

### PRIORITY CLAIM

This patent application claims priority from European patent application number EP24181767 filed on Jun. 12, 2024, and from British (United Kingdom) patent application number 2408473.3 filed on Jun. 13, 2024, the entire disclosures of which are incorporated herein by reference.

### SUMMARY

An advertisement request allocation platform includes: a monitoring module comprising an offer rate builder, the offer rate builder configured to periodically determine a utilization rate using a plurality of candidate time windows, wherein the utilization rate for a combination of a group of advertisement requests and a demand-side platform (DSP) comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP, wherein the offer rate builder is further configured to determine the utilization rate by: determining (i) a utilization rate and (ii) a measure of variability of the utilization rate for a plurality of candidate time windows; determining, for one or more of the plurality of candidate time windows, a first adjusted rate, wherein the first adjusted rate comprises the utilization rate plus the measure of variability for that candidate time window; determining, for one or more of the plurality of candidate time windows, a second adjusted rate, wherein the second adjusted rate comprises the utilization rate minus the measure of variability for that candidate time window; identifying a first finalist time window from the plurality of candidate time windows, wherein the first finalist time window is the candidate time window for which the first adjusted rate is at a minimum; identifying a second finalist time window from the plurality of candidate time windows, wherein the second finalist time window is the candidate time window for which the second adjusted rate is at a maximum; selecting the shorter of the first finalist time window and the second finalist time window as the selected time window; determining the utilization rate for the selected time window as the utilization rate for the combination; determining the optimum offer rate at which to send the advertisement request to the DSP; and sending advertisement requests to the DSP using the optimum offer rate.

An advertisement request allocation platform includes: a monitoring module comprising an offer rate builder, the offer rate builder configured to periodically determine a utilization rate using a plurality of candidate time windows, wherein the utilization rate for a combination of a group of advertisement requests and a demand-side platform (DSP) comprises a rate at which the DSP utilizes the group, wherein the group comprises advertisement requests sharing one or more advertisement request parameters, the offer rate builder further configured to periodically determine for the combination a measure of variability of the utilization rate, wherein the offer rate builder determines the optimum offer rate to be the higher of (i) a predetermined minimum offer rate and (ii) a determined offer rate determined based on the utilization rate and the available advertisement requests, using the equation:

$$determined offer\_rate = \frac{utilization rate * offers\_sent * n}{available requests}$$

wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send; and an offer module operably connected to the DSP, the offer module configured to send the advertisement request to the DSP, wherein the offer rate builder is further configured to determine for the combination an optimum offer rate at which to send the advertisement request to the DSP, wherein the offer module further comprises an auction module, wherein the auction module is configured to receive an advertisement request in an auction from the DSP, wherein the offer module is further configured to send the advertisement request to all DSPs to which the offer generator determines that the advertisement request should be sent, wherein the auction module is further configured to receive the optimum offer rate from the offer rate builder, wherein the auction module is further configured to use the optimum offer rate when sending the advertisement request to the DSP, wherein when the utilization rate is less than a first threshold, the auction module is further configured to send the advertisement request at a minimum offer rate, wherein when the utilization rate is more than a second threshold, the auction module is further configured to send the advertisement request at a maximum offer rate, wherein for a utilization rate between the first threshold and the second threshold, the auction module is further configured to send the advertisement request at a determined offer rate that is proportional to the utilization rate wherein the auction module is further configured to send the advertisement request at a minimum offer rate when the utilization rate is below a minimum threshold, wherein the auction module is further configured to send the advertisement request at a maximum offer rate when the utilization rate is above a maximum threshold, wherein the auction module is further configured to send the advertisement request at a determined offer rate that is proportional to the utilization rate, wherein the auction module is further configured to receive from the DSP a desired engagement rate, wherein the desired engagement rate comprises a desired number of advertisement requests per advertisement utilized by the DSP, wherein the offer module further comprises an advertisement request interface, the advertisement request interface operably connected to the end user, the advertisement request interface also operably connected to the auction module, wherein the advertisement request interface is configured to receive the advertisement request from the end user, wherein the advertisement request interface is further configured to identify a winning advertisement request, wherein the advertisement request interface is further configured to send the winning advertisement to the end user that sent the advertisement request, wherein the advertisement request interface receives a notification of utilization of the advertisement from the end user, wherein the offer module further comprises an offer generator, the offer generator operably connected to the advertisement request interface, wherein the offer generator is configured to receive an advertisement request from the advertisement request interface, wherein the offer generator is configured to determine the group to which the advertisement request belongs, wherein the offer module further comprises a logging module, the logging module operably connected to the advertisement request interface, the logging module configured to log the advertisement request, wherein the monitoring module further comprises storage, the storage operably connected to the offer generator, the storage further operably connected to the logging module, the storage further operably connected to the offer rate builder, wherein the storage is configured to store one or more of the advertisement request and advertisement utilization data, wherein the storage comprises stored optimum offer rates for combinations of the group and the DSP, wherein the offer generator retrieves the stored optimum offer rate for at least one combination, wherein, using the retrieved optimum offer rate, for at least one DSP, the offer generator makes a determination whether to send the advertisement request to the DSP, wherein the offer generator sends the determination to the advertisement request interface, wherein the offer generator is configured to send the advertisement request at a minimum offer rate when the utilization rate is below a minimum threshold, wherein the offer rate builder is further configured to determine the utilization rate by: determining (i) a utilization rate and (ii) a measure of variability of the utilization rate for a plurality of candidate time windows, wherein the candidate time windows comprise a plurality of time windows having a common end time and different start times; determining, for one or more of the plurality of candidate time windows, a first adjusted rate, wherein the first adjusted rate comprises the utilization rate plus the measure of variability for that candidate time window; determining, for one or more of the plurality of candidate time windows, a second adjusted rate, wherein the second adjusted rate comprises the utilization rate minus the measure of variability for that candidate time window; identifying a first finalist time window from the plurality of candidate time windows, wherein the first finalist time window is the candidate time window for which the first adjusted rate is at a minimum; identifying a second finalist time window from the plurality of candidate time windows, wherein the second finalist time window is the candidate time window for which the second adjusted rate is at a maximum; selecting the shorter of the first finalist time window and the second finalist time window as the selected time window; determining the utilization rate for the selected time window as the utilization rate for the combination; determining the optimum offer rate at which to send the advertisement request to the DSP; and sending advertisement requests to the DSP using the optimum offer rate.

A method of determining an optimum offer rate at which to send an advertisement request to a demand-side platform (DSP) comprising, by an advertisement request allocation platform comprising a monitoring module comprising an offer rate builder, the offer rate builder configured to periodically determine a utilization rate using a plurality of candidate time windows, wherein the utilization rate for a combination of a group of advertisement requests and a DSP comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP: determining (i) a utilization rate and (ii) a measure of variability of the utilization rate for a plurality of candidate time windows; determining, for one or more of the plurality of candidate time windows, a first adjusted rate, wherein the first adjusted rate comprises the utilization rate plus the measure of variability for that candidate time window; determining, for one or more of the plurality of candidate time windows, a second adjusted rate, wherein the second adjusted rate comprises the utilization rate minus the measure of variability for that candidate time window; identifying a first finalist time window from the plurality of candidate time windows, wherein the first finalist time window is the candidate time window for which the first adjusted rate is at a minimum; identifying a second finalist time window from the plurality of candidate time windows, wherein the second finalist time window is the candidate time window for which the second adjusted rate is at a maximum; selecting the shorter of the first finalist time window and the second finalist time window as the selected time window; determining the utilization rate for the selected time window as the utilization rate for the combination; determining the optimum offer rate at which to send the advertisement request to the DSP; and sending advertisement requests to the DSP using the optimum offer rate.

A method of determining an optimum offer rate at which to send an advertisement request to a demand-side platform (DSP) includes: by an advertisement request allocation platform comprising a monitoring module comprising an offer rate builder, the offer rate builder configured to periodically determine a utilization rate using a plurality of candidate time windows, wherein the candidate time windows comprise a plurality of time windows having a common end time and different start times, wherein the utilization rate for a combination of a group of advertisement requests and a DSP comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP: determining (i) a utilization rate and (ii) a measure of variability of the utilization rate for a plurality of candidate time windows; determining, for one or more of the plurality of candidate time windows, a first adjusted rate, wherein the first adjusted rate comprises the utilization rate plus the measure of variability for that candidate time window; determining, for one or more of the plurality of candidate time windows, a second adjusted rate, wherein the second adjusted rate comprises the utilization rate minus the measure of variability for that candidate time window; identifying a first finalist time window from the plurality of candidate time windows, wherein the first finalist time window is the candidate time window for which the first adjusted rate is at a minimum; identifying a second finalist time window from the plurality of candidate time windows, wherein the second finalist time window is the candidate time window for which the second adjusted rate is at a maximum; selecting the shorter of the first finalist time window and the second finalist time window as the selected time window; determining the utilization rate for the selected time window as the utilization rate for the combination by dividing a number of advertisement requests utilized by a number of advertisement requests sent to the DSP; determining the optimum offer rate at which to send the advertisement request to the DSP; sending advertisement requests to the DSP using the optimum offer rate, wherein the sending step comprises sending the advertisement request at a minimum offer rate when the utilization rate is below a first threshold, wherein the sending step further comprises sending the advertisement request at a maximum offer rate when the utilization rate is above a second threshold, wherein for a utilization rate between the first threshold and the second threshold, the sending step further comprises sending the advertisement request at a determined offer rate that is proportional to the utilization rate, wherein the method further comprises determining the optimum offer rate to be the higher of (i) a predetermined minimum offer rate and (ii) a determined offer rate determined based on the utilization rate and the available advertisement requests, wherein the method further comprises computing the determined offer rate using the equation:

$$determined offer\_rate = \frac{utilization rate * offers\_sent * n}{available requests}$$

wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send, wherein the sending step comprises sending the advertisement request at a minimum offer rate when the utilization rate is below a minimum threshold; and receiving a notification of utilization of the advertisement from the end user.

### BRIEF DESCRIPTION OF THE FIGURES

FIG. 1 is a drawing of an environment comprising the advertisement request allocation platform, an end user and a demand-side platform (DSP).

FIG. 2 is a drawing of an environment in which an advertisement request allocation platform provides an advertisement request allocation service for a plurality of DSPs.

FIG. 3 is a flow chart of a method 300 an optimum offer rate at which to send an advertisement request to a demand-side platform.

FIG. 4 is a flow chart of a method 400 an optimum offer rate at which to send an advertisement request to a demand-side platform.

### DETAILED DESCRIPTION

An advertisement request allocation platform reduces a number of advertisement requests sent to Demand Side Platforms (DSPs), only sending advertisement requests to a DSP that the DSP is relatively likely to accept. The advertisement request allocation platform achieves this by controlling a flow of information. For example, the advertisement request allocation platform is configured to adjust within approximately thirty minutes when the DSP's bidding behavior changes.

In essence, the advertisement request allocation platform acts as one or more of a smart filter and a smart regulator, ensuring that the right advertisement requests reach the right DSPs at the right time, enhancing one or more of overall efficiency and effectiveness of the programmatic advertising ecosystem.

Examples herein relate to systems and methods for determining an optimum offer rate of an advertisement request, and sending an advertisement request at the optimum offer rate.

A utilization rate comprises a rate at which the DSP utilizes the group. More specifically, the utilization rate comprises an impression rate, that is, the utilization rate comprises a number of impressions per advertisement request sent to the DSP. More specifically, the utilization rate comprises a number of advertisement requests utilized by the DSP in a selected time window divided by a number of advertisement requests sent to the DSP during the selected time window. The utilization rate thus comprises a measure of utilization of advertisement requests by the DSP. For example, an impression comprises a display of an advertisement on an end user device.

A bid rate comprises a number of bids made by the DSP per advertisement request sent to the DSP. Realized cost per mille (rCPM) comprises revenue received from the DSP per 1 million advertisement requests sent to the DSP. Alternatively, the utilization rate comprises one or more of the bid rate, the impression rate, rCPM, a click rate, a product purchase rate, and another measure of utilization of the advertisement requests.

The end user device comprises an advertisement spot configured to display an advertisement to the end user. The advertisement spot comprises one or more of an area reserved for an advertisement within a webpage displayed by the end user device and a portion of an application of the end user device that is reserved for the advertisement. The advertisement spot comprises one or more of a webpage and a mobile app, the advertisement spot comprising a space reserved to display the advertisement.

When the end user views an end user device where there is a space reserved for the advertisement, and therefore the end user device comprises the advertisement spot, the end user device sends an advertisement request to a Supply Side Platform (SSP). The SSP sends the advertisement request to one or more DSPs.

A group of advertisement requests comprises advertisement requests sharing one or more advertisement request parameters. An advertisement request parameter comprises a parameter relating to an advertisement request that the advertisement request allocation platform associates with the advertisement request. The advertisement request parameter comprises one or more of a mobile app that originates the advertisement request for an end user that is viewing a part of the mobile app reserved for display of an advertisement, a webpage that originates the advertisement request for the end user that is viewing the webpage reserved for display of an advertisement, a format of the advertisement comprised in the advertisement request, a supply-side platform (SSP) that sent the advertisement request to the DSP, a country of origin of the advertisement request, an auction type of a real-time auction running on the SSP, an end user device type, an advertisement type, an advertisement publisher, an identifier of the SSP, a location of the end user device, and another advertisement request parameter.

An advertisement request allocation platform comprises: a monitoring module configured to periodically determine a utilization rate over a selected time window, wherein the utilization rate comprises a number of advertisement requests utilized by the DSP in a selected time window divided by a number of advertisement requests sent to the DSP during the selected time window, the monitoring module further configured to periodically determine a measure of variability of the utilization rate; and an offer module configured to send the advertisement request to the DSP, wherein the monitoring module is further configured to compute for at least one combination of a group and a DSP an optimum offer rate at which to send the advertisement request to the DSP. Preferably, but not necessarily, the monitoring module computes the optimum offer rate for each combination.

The monitoring module is configured to determine the utilization rate for a combination of a group and a DSP. Preferably, but not necessarily, the monitoring module is configured to determine the utilization rate for each combination. The monitoring module is further configured to periodically determine a measure of variability of the utilization rate for the combination. Preferably, but not necessarily, the monitoring module is configured to determine the measure of variability for each combination.

The monitoring module determines the utilization rate by: determining for the combination of the group and the DSP (i) a utilization rate and (ii) a measure of variability of the utilization rate for at least one of a plurality of candidate time windows; determining, for the selected time window, a first adjusted rate, wherein the first adjusted rate comprises the utilization rate plus the measure of variability for the selected time window; determining, for the selected time window, a second adjusted rate, wherein the second adjusted rate comprises the utilization rate minus the measure of variability for the selected time window; identifying a first finalist time window, wherein the first finalist time window is the candidate time window for which the first adjusted rate is at a minimum; identifying a second finalist time window, wherein the second finalist time window is the candidate time window for which the second adjusted rate is at a maximum; selecting as a selected time window the shorter of the first finalist time window and the second finalist time window; and determining a utilization rate for the combination using the selected time window.

The measure of variability comprises one or more of a standard error, a standard deviation, an inter-quartile range, a decile range, a confidence interval, and another measure of variation of data.

The candidate time windows comprise different periods of time during which a DSP utilizes advertisement requests. For example, the candidate time windows comprise a plurality of time windows having a common end time and different start times. After the common end time of the candidate time windows occurs, the advertisement request allocation platform computes the utilization rate for the combination.

The candidate time windows may increase in length monotonically, for example, a successive time window being n seconds longer than an immediately shorter time window, wherein n may comprise any number.

For example, a set of candidate time windows (CWs) may comprise:

$${CW}_{1} = ( {T}_{end} - 1 minute ) to {T}_{end}$$

$${CW}_{2} = ( {T}_{end} - 2 minutes ) to {T}_{end}$$

$$…$$

$${CW}_{N} = ( {T}_{end} - N minutes ) to {T}_{end} ,$$

where T_{end} comprises the common end time. While each successive candidate time window is one minute longer than the last in this example, other time differences may be used in other embodiments.

For example, a time window may have a duration of one or more of a few seconds, 1 minute, ten minutes, and another duration.

The monitoring module determines the measure of variability of the utilization rate for at least one of the plurality of candidate time windows. Preferably, but not necessarily, the monitoring module determines the measure of variability of the utilization rate for each of the plurality of candidate time windows.

The monitoring module determines the first adjusted rate for at least one of the plurality of candidate time windows. Preferably, but not necessarily, the monitoring module determines the first adjusted rate for each of the plurality of candidate time windows.

The monitoring module determines the second adjusted rate for at least one of the plurality of candidate time windows. Preferably, but not necessarily, the monitoring module determines the second adjusted rate for each of the plurality of candidate time windows.

The advertisement request comprises advertisement request data. The advertisement request data comprises end user data. The end user data comprises one or more of end user personal data, end user device data, contextual data, advertisement spot data, website data, mobile app data, network data, and privacy data.

The end user personal data comprises one or more of demographic data, location data, and behavioral data. The demographic data comprises one or more of an end user age, an end user gender, an end user income level, an end user education, and the like. The location data comprises one or more of an end user Global Position System (GPS) coordinate, an end user Internet Protocol (IP) address, an end user country, an end user city, and an end user postal code. The behavioral data comprises one or more of an end user browsing history, an end user search query, an end user purchase history, and other end user behavioral data.

The end user device data comprises one or more of an end user device type, an end user device operating system, an end user device make, an end user device model, end user device browser information, an end user device identifier, and an end user device screen resolution. The end user device type comprises one or more of mobile, desktop, tablet, and another end user device type. The end user device operating system comprises one or more of iPhone Operating System (IOS), Android, Windows, Mac Operating System (macOS), and another end user device operating system. The end user device browser information comprises one or more of a type of browser that the end user is using and a version of the browser that the end user is using. The end user device identifier comprises one or more of an Identifier for Advertisers (IDFA) device identifier, a Google Advertising Identifier (GAID) device identifier, and another end user device identifier. The end user device screen resolution comprises one or more of an end user device screen dimension and an end user device screen pixel density.

The contextual data comprises one or more of a Uniform Resource Locator (URL) of a webpage where the advertisement is to be displayed, page content data, and advertisement placement data. The page content data comprises one or more of a content keyword, a content category, and the like. The advertisement placement data comprises one or more of a position of the advertisement and a size of the advertisement.

The advertisement spot data comprises one or more of an advertisement spot dimension, an advertisement spot unique identifier, an advertisement spot format, and advertisement spot visibility data. The advertisement spot format comprises one or more of a banner, a video, a native advertisement, and another advertisement spot format. The advertisement spot visibility data comprises one or more of an advertisement visibility metric and an advertisement visibility prediction.

The website data comprises one or more of a website identifier, a category of a website, and website information. The mobile app data comprises one or more of a mobile app identifier, a category of a mobile app, and app information. The site information comprises one or more of a name of the site and a description of the site. The app information comprises one or more of a name of the app and a description of the app.

The network data comprises one or more of an Internet Protocol (IP) address, a connection type, and Internet Service Provider (ISP) data. The connection type comprises one or more of a Wireless Fidelity (Wi-Fi) connection, a cellular data connection, a wired connection, and another connection type. The ISP data comprises one or more of an ISP name, an ISP location, and other ISP data.

The privacy data comprises one or more of a consent string and an opt-out flag. The consent string comprises information about end user content. For example, the consent string comprises General Data Protection Regulation (GDPR) compliance data. For example, the consent string is usable for one or more of data collection and advertisement targeting. The opt-out flag comprises an indicator that the end user has opted out of a data collection practice.

The advertisement request allocation platform is configured to compute the utilization rate. For example, the advertisement request allocation platform computes the utilization rate by dividing a number of advertisement requests utilized by a number of advertisement requests sent to the DSP.

In some embodiments, when the utilization rate is less than a first threshold, the auction module is configured to offer the advertisement request at a minimum offer rate. For example, the first threshold comprises 1%. In other embodiments, when the utilization rate is more than a second threshold, the auction module is configured to send the advertisement request at a maximum optimum offer rate. For example, the second threshold comprises 100%. For at least some utilization rates, for example, for utilization rates between the first threshold and the second threshold, the auction module is configured to send the advertisement request at a determined offer rate that is proportional to the utilization rate.

The auction module is configured to receive the bid from the DSP. The auction module is further configured to receive from the DSP a desired engagement rate. The desired engagement rate comprises a desired number of advertisement requests per advertisement utilized by the DSP. Alternatively, the desired engagement rate comprises one or more of a desired number of advertisement requests per dollar of revenue, a desired number of advertisement requests per bid, a desired number of advertisement requests per rCPM, and a desired number of advertisement requests per hour desired by the DSP. The auction module is further configured to receive from the DSP a minimum threshold. When the utilization rate is below the minimum threshold, the offer generator is configured to send the advertisement request at the minimum offer rate.

The auction module is further configured to send the DSP the one or more of the desired number of advertisement requests per impression, the desired number of advertisement request per dollar of revenue, and the number of advertisement requests per hour desired by the DSP.

The advertisement request allocation platform determines the determined offer rate using one or more of the utilization rate and a number of available advertisement requests. Preferably, but not necessarily, the advertisement request allocation platform determines the determined offer rate using both the utilization rate and the number of available advertisement requests.

The offer rate builder determines an optimum offer rate to be applied to a number of available advertisement requests by determining the higher of (i) the predetermined minimum offer rate and (ii) the determined offer rate that the advertisement request allocation platform computes using the equation:

$$determined offer\_rate = \frac{utilization rate * offers\_sent * n}{available requests}$$

wherein utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per hour, and available requests comprises the number of advertisement requests that were available for the advertisement request allocation platform to send.

For example, a determined offer rate of 0.1 means that the advertisement request allocation platform sends 10% of the available advertisement requests to the DSP, and does not send 90% of the available advertisement requests to the DSP. A determined offer rate of 0.7 means that the advertisement request allocation platform sends 70% of the available advertisement requests to the DSP. If the determined offer rate is 0.2 and the minimum offer rate is 0.1, then the advertisement request allocation platform uses the determined offer rate. If the determined offer rate is 0.05 and the maximum offer rate is 0.1, then the advertisement request allocation platform uses the minimum offer rate.

The advertisement request allocation platform comprises an auction module operably connected to the DSP, the auction module configured to oversee auctions in which the advertisement request allocation platform is involved. The auction module is further configured to receive the optimum offer rate from the offer rate builder. The auction module is further configured to use the optimum offer rate when sending the advertisement request to the DSP. The auction module is further configured to send the advertisement request at the minimum offer rate when the utilization rate is below a minimum threshold. The auction module is further configured to send the advertisement request at the maximum offer rate when the utilization rate is above a maximum threshold.

FIG. 1 is a drawing of an environment comprising an advertisement request allocation platform, an end user and a demand-side platform (DSP).

An online digital advertising campaign environment 100 comprises an advertisement request allocation platform 105. The advertisement request allocation platform is configured to perform an advertisement request allocation service. The advertisement request allocation platform 105 comprises a monitoring module 110. The advertisement request allocation platform 105 further comprises an offer module 120 operably connected to the monitoring module 110.

The environment 100 further comprises a DSP 125 operably connected to the offer module 120, the DSP 125 configured to send an advertisement request to the offer module 120. The advertisement request allocation platform 105 performs the advertisement request allocation service for the DSP 125. The offer module 120 is configured to send the advertisement request to the DSP 125.

The environment 100 further comprises an end user 127. A group of advertisement requests comprises advertisement requests sharing one or more advertisement request parameters. The end user 127 is operably connected to the offer module 120. The offer module 120 is further configured to determine a rate at which an advertisement request is sent to the DSP 125 based, at least in part, on the utilization rate for the group. As described in greater detail below, the offer module 120 determines an optimum offer rate using one or more of a determined offer rate and a minimum offer rate.

The offer module 120 further comprises an advertisement request interface 130. The advertisement request interface 130 is operably connected to the end user 127. The advertisement request interface 130 is further operably connected to the end user 127. The advertisement request interface 130 accepts the advertisement requests from one or more of an end user 127 and the SSP.

The offer module 120 further comprises an offer generator 140. The offer generator 140 is operably connected to the advertisement request interface 130. The offer generator 140 is configured to receive an advertisement request from the advertisement request interface 130. Preferably, but not necessarily, the offer generator receives each advertisement request from the advertisement request interface 130. The offer generator 140 is configured to determine the group to which the advertisement request belongs. Preferably, but not necessarily, the offer generator 140 is configured to determine the group using the advertisement request data comprised in the advertisement request. The offer generator 140 maintains a list of DSPs 125 to which the advertisement request interface 130 can send the advertisement request.

The offer module 120 further comprises an auction module 150. The auction module 150 is operably connected to the DSP 125. The auction module 150 is also operably connected to the advertisement request interface 130. The auction module 150 is configured to oversee auctions in which the advertisement request allocation platform 105 is involved. The advertisement request interface 130 sends the advertisement request to the auction module 150. The auction module 150 handles allocation of competing bids from multiple DSPs 125. The auction module 150 runs an auction in real-time and sends the advertisement request to all DSPs 125 for which the offer generator 140 made a determination to send the advertisement request to the DSP 125.

When the DSP 125 receives an advertisement request, the DSP 125 can bid to display an advertisement on an end user device (not shown in FIG. 1; item 210 in FIG. 2) controlled by the end user 127. When the auction module 150 receives a bid from a DSP 125, the auction module 150 uses the bid to determine a DSP 125 placing the highest bid, which comprises a winning bid corresponding to a winning advertisement. The advertisement request interface 130 identifies the winning advertisement request corresponding to the winning advertisement. The advertisement request interface 130 sends the winning advertisement to the end user 127 that originated the advertisement request.

The offer module 120 further comprises a logging module 160. The logging module 160 is operably connected to the advertisement request interface 130. The logging module 160 logs an advertisement request that passes through the advertisement request interface 130. Preferably, but not necessarily, the logging module 160 logs each advertisement request that passes through the advertisement request interface 130.

The monitoring module 110 further comprises storage 170. The storage 170 is operably connected to the offer generator 140. The storage 170 is further operably connected to the logging module 160. The storage 170 is configured to store one or more of an advertisement request and advertisement utilization data. Preferably, but not necessarily, the storage 170 is configured to store both the advertisement request and the advertisement utilization data. The advertisement request interface 130 is further configured to receive a notification of utilization of the advertisement from the end user 127 confirming that the advertisement was displayed successfully on the end user device. The advertisement request interface 130 is configured to send the notification of utilization to the logger 160, which then stores the notification of utilization in the storage 170.

The logging module 160 logs in the storage 170 an advertisement request that passes through the advertisement request interface. Preferably, but not necessarily, the logging module 160 logs in the storage 170 all advertisement requests passing through the advertisement request interface 130. The advertisement requests passing through the advertisement request interface 130 comprise one or more of inbound advertisement requests and outbound advertisement requests. Preferably, but not necessarily, the advertisement requests passing through the advertisement request interface 130 comprise both inbound advertisement requests and outbound advertisement requests.

The monitoring module 110 further comprises an offer rate builder 180. The offer rate builder is operably connected to the storage 170. The offer rate builder 180 is configured to retrieve from the storage 170 one or more of the advertisement request, the advertisement utilization data, and the notification. The offer rate builder 180 uses the one or more of the advertisement request and the advertisement utilization data to determine an optimum offer rate for at least one combination based, at least in part, on the utilization rate for the combination. Preferably, but not necessarily, the offer rate builder 180 determines the optimum offer rate for each combination using one or more of a determined offer rate and a minimum offer rate.

The offer rate builder 180 then stores the optimum offer rate in the storage 170. For example, the offer rate builder determines the optimum offer rate periodically. For example, the offer rate builder 180 determines the optimum offer rate every ten minutes.

As discussed in more detail above, the notification comprises advertisement request data. The advertisement request data comprises end user data. The end user data comprises one or more of end user personal data, end user device data, contextual data, advertisement spot data, website data, mobile app data, network data, and privacy data.

The offer generator 140 queries the storage 170 to refresh its cache of optimum offer rates. Preferably, but not necessarily, the offer generator 140 queries the storage 170 to refresh its cache of all optimum offer rates. For example, the offer generator 140 queries the storage once per minute.

The offer rate builder 180 is configured to determine the utilization rate for a combination of a group and the DSP 125. For example, the offer rate builder 180 computes the utilization rate by dividing a number of advertisement requests utilized by a number of advertisement requests sent to the DSP 125.

The offer rate builder 180 is further configured to periodically determine a measure of variability of the utilization rate for the combination. Preferably, but not necessarily, the monitoring module 110 is configured to determine the utilization rate for each combination. Preferably, but not necessarily, the monitoring module 110 is configured to determine the measure of variability for each combination.

The offer rate builder 180 determines the measure of variability of the utilization rate for at least one of the plurality of candidate time windows. Preferably, but not necessarily, the offer rate builder 180 determines the measure of variability of the utilization rate for each of the plurality of candidate time windows.

The offer rate builder 180 is further configured to determine, for at least one of the plurality of candidate time windows, a first adjusted rate, wherein the first adjusted rate comprises the utilization rate of a candidate time window plus the measure of variability for that candidate time window. Preferably, but not necessarily, the offer rate builder 180 is further configured to determine the first adjusted rate for each of the plurality of candidate time windows.

The offer rate builder 180 is further configured to determine, for at least one of the plurality of candidate time windows, a second adjusted rate, wherein the second adjusted rate comprises the utilization rate of the candidate time window minus the measure of variability for that candidate time window. Preferably, but not necessarily, the offer rate builder 180 is further configured to determine the second adjusted rate for each of the plurality of candidate time windows.

The offer rate builder 180 is further configured to identify a first finalist time window, wherein the first finalist time window comprises the candidate time window for which the first adjusted rate is at a minimum. The offer rate builder 180 is further configured to identify a second finalist time window, wherein the second finalist time window comprises the candidate time window for which the second adjusted rate is at a maximum.

The offer rate builder 180 is further configured to select the shorter of the first and second candidate time windows as the selected time window, and to determine the utilization rate for that window as the utilization rate for the combination of the group and the DSP.

The offer rate builder 180 determines an optimum offer rate to be applied to a number of available advertisement requests by determining the higher of (i) the predetermined minimum offer rate and (ii) a determined offer rate that the offer rate builder 180 computes using the equation:

$$determined offer\_rate = \frac{utilization rate * offers\_sent * n}{available requests}$$

wherein utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per hour, and available requests comprises the number of advertisement requests that were available for the advertisement request allocation platform 105 to send.

The storage 170 comprises stored optimum offer rates for combinations of the group and the DSP 125. Preferably, but not necessarily, the storage 170 comprises stored optimum offer rates for all combinations. The offer generator 140 retrieves from the storage 170 the stored optimum offer rate for at least one combination. Preferably, but not necessarily, the offer generator 140 retrieves the stored optimum offer rate for each combination. Using the retrieved optimum offer rate, for at least one DSP 125, the offer generator 140 makes a determination whether to send the advertisement request to the DSP 125. Preferably, but not necessarily, using the retrieved optimum offer rate, for each DSP 125, the offer generator 140 makes a determination whether to send the advertisement request to the DSP 125. For example, if the optimum offer rate for a DSP is 0.1, the offer generator 140 may generate a random number between 0 and 1 and if that random number is less than 0.1, the offer generator 140 determines to send the advertisement request. If the random number id greater than or equal to 0.1, the offer generator 140 determines not to send the advertisement request. The offer generator 140 sends the determination for the DSP 125 to the advertisement request interface 130. Preferably, but not necessarily, the offer generator 140 sends the determination for each DSP 125 to the advertisement request interface 130. The offer generator 140 is configured to offer the advertisement request at a minimum offer rate when the utilization rate is below a minimum threshold.

The offer rate builder 180 sends the optimum offer rate to the auction module 150. The auction module 150 then sends offers using the optimum offer rate.

FIG. 2 is a drawing of an online digital advertising campaign environment 200 in which the advertisement request allocation platform 105 provides an advertisement request allocation service for a plurality of DSPs 125A . . . 125Z. The environment 200 further comprises the DSPs 125A . . . 125Z, which are operably connected to the advertisement request allocation platform. The environment 200 further comprises the end user 127. The end user 127 comprises an end user device 210 controlled by the end user 127. The end user device 210 comprises one or more of a computer, a mobile phone, and another end user device 210. The end user device 210 comprises one or more of a mobile end user device 210 and a non-mobile end user device 210.

The end user device 210 comprises an advertisement spot 220 configured to display an advertisement to the end user 127. The advertisement spot 220 comprises one or more of an area reserved for an advertisement within a webpage displayed by the end user device 210 and a portion of an application of the end user device 210 that is reserved for an advertisement. The advertisement spot 220 comprises one or more of a webpage and a mobile app the advertisement spot 220 comprising a space reserved to display an advertisement.

The environment 200 further comprises an SSP 230. The SSP 230 is operably connected to the advertisement request allocation platform 105. The SSP 230 is also operably connected to the end user 127. The end user 127, using the end user device 210, views the advertisement spot 220. As the end user 127 views the advertisement spot 220, the advertisement spot 220 automatically sends the advertisement request to the SSP 230. The SSP 230 sends the advertisement request to the advertisement request allocation platform 105. The SSP 230 then fills the advertisement request using the winning advertisement received from the advertisement request interface 130. The SSP 230 then sends an advertisement (not shown in FIG. 2) to the advertisement spot 220.

The environment 200 further comprises a plurality of advertisers 240A . . . 0.240Z. The advertisers 240A . . . 240Z are operably connected to respective DSPs 125A . . . 125Z. Preferably, but not necessarily, an advertiser 240A . . . 240Z creates a contract with a DSP 125A . . . 125Z to serve a number of advertisements for an advertising campaign. The DSP 125 A . . . 125Z then displays these advertisements to the end user 127. Preferably, but not necessarily, the DSP 125A . . . 125Z displays the advertisements to a plurality of end users 210. Usually, the advertiser 240 will judge the success of the campaign by some metric measuring the end user's 210 engagement with the advertisements. It is therefore important to the DSP 125A . . . 125Z that the advertiser 240 send the advertisements to the end users 210 most likely to engage with the advertisement.

FIG. 3 is a flow chart of a method 300 for determining an optimum offer rate at which to send an advertisement request to a demand-side platform (DSP).

The order of the steps in the method 300 is not constrained to that shown in FIG. 3 or described in the following discussion. Several of the steps could occur in a different order without affecting the final result.

In step 310, an advertisement request allocation platform, the comprising a monitoring module comprising an offer rate builder, the offer rate builder configured to periodically determine a utilization rate using a plurality of candidate time windows, wherein the utilization rate for a combination of a group of advertisement requests and a demand-side platform comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP, determines (i) a utilization rate and (ii) a measure of variability of the utilization rate for a plurality of candidate time windows. Block 310 then transfers control to block 320.

In step 320, the advertisement request allocation platform determines, for one or more of the plurality of candidate time windows, a first adjusted rate, wherein the first adjusted rate comprises the utilization rate plus the measure of variability for that candidate time window. Block 320 then transfers control to block 330.

In step 330, the advertisement request allocation platform determines, for one or more of the plurality of candidate time windows, a second adjusted rate, wherein the second adjusted rate comprises the utilization rate minus the measure of variability for that candidate time window. Block 330 then transfers control to block 340.

In step 340, the advertisement request allocation platform identifies a first finalist time window from the plurality of candidate time windows, wherein the first finalist time window is the candidate time window for which the first adjusted rate is at a minimum. Block 340 then transfers control to block 350.

In step 350, the advertisement request allocation platform identifies a second finalist time window from the plurality of candidate time windows, wherein the second finalist time window is the candidate time window for which the second adjusted rate is at a maximum. Block 350 then transfers control to block 360.

In step 360, the advertisement request allocation platform selects the shorter of the first finalist time window and the second finalist time window as the selected time window. Block 360 then transfers control to block 370.

In step 370, the advertisement request allocation platform determines the utilization rate for the selected time window as the utilization rate for the combination by dividing a number of advertisement requests utilized by a number of advertisement requests sent to the DSP. Block 370 then transfers control to block 380.

In step 380, the advertisement request allocation platform determines the optimum offer rate at which to send the advertisement request to the DSP. Block 380 then transfers control to block 390.

In step 390, the advertisement request allocation platform sends advertisement requests to the DSP using the optimum offer rate. Block 390 then terminates the process.

FIG. 4 is a flow chart of a method 400 for determining an optimum offer rate at which to send an advertisement request to a demand-side platform (DSP).

The order of the steps in the method 400 is not constrained to that shown in FIG. 4 or described in the following discussion. Several of the steps could occur in a different order without affecting the final result.

In step 410, an advertisement request allocation platform comprising a monitoring module comprising an offer rate builder, the offer rate builder configured to periodically determine a utilization rate using a plurality of candidate time windows, wherein the utilization rate for a combination of a group of advertisement requests and a demand-side platform comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP, determines (i) a utilization rate and (ii) a measure of variability of the utilization rate for a plurality of candidate time windows. Block 410 then transfers control to block 420.

In step 420, the advertisement request allocation platform determines, for one or more of the plurality of candidate time windows, a first adjusted rate, wherein the first adjusted rate comprises the utilization rate plus the measure of variability for that candidate time window. Block 420 then transfers control to block 430.

In step 430, the advertisement request allocation platform determines, for one or more of the plurality of candidate time windows, a second adjusted rate, wherein the second adjusted rate comprises the utilization rate minus the measure of variability for that candidate time window. Block 430 then transfers control to block 440.

In step 440, the advertisement request allocation platform identifies a first finalist time window from the plurality of candidate time windows, wherein the first finalist time window is the candidate time window for which the first adjusted rate is at a minimum. Block 440 then transfers control to block 450.

In step 450, the advertisement request allocation platform identifies a second finalist time window from the plurality of candidate time windows, wherein the second finalist time window is the candidate time window for which the second adjusted rate is at a maximum. Block 450 then transfers control to block 460.

In step 460, the advertisement request allocation platform selects the shorter of the first finalist time window and the second finalist time window as the selected time window. Block 460 then transfers control to block 470.

In step 470, the advertisement request allocation platform determines the utilization rate for the selected time window as the utilization rate for the combination by dividing a number of advertisement requests utilized by a number of advertisement requests sent to the DSP. Block 470 then transfers control to block 480.

In step 480, the advertisement request allocation platform determines the optimum offer rate at which to send the advertisement request to the DSP. Block 480 then transfers control to block 490.

In step 490, the advertisement request allocation platform sends advertisement requests to the DSP using the optimum offer rate, wherein the sending step comprises sending the advertisement request at a minimum offer rate when the utilization rate is below a first threshold, wherein the sending step further comprises sending the advertisement request at a maximum offer rate when the utilization rate is above a second threshold, wherein for a utilization rate between the first threshold and the second threshold, the sending step further comprises sending the advertisement request at a determined offer rate that is proportional to the utilization rate, wherein the method further comprises determining the optimum offer rate to be the higher of (i) a predetermined minimum offer rate and (ii) a determined offer rate determined based on the utilization rate and the available advertisement requests, wherein the method further comprises computing the determined offer rate using the equation:

$$determined offer\_rate = \frac{utilization rate * offers\_sent * n}{available requests}$$

wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send, wherein the sending step comprises sending the advertisement request at a minimum offer rate when the utilization rate is below a minimum threshold; and receiving a notification of utilization of the advertisement from the end user. Block 490 then transfers control to block 495.

In step 495, the advertisement request allocation platform receives a notification of utilization of the advertisement from the end user. Block 495 then terminates the process.

An advantage of embodiments of the invention is that the advertisement request allocation platform manages a flow of bid requests between SSPs and DSPs. Another advantage of embodiments of the invention is that the advertisement request allocation platform is configured to match up supply (from the SSP) with demand (from the DSP).

One advantage of embodiments of the invention is that by sending to a given DSP only advertisement requests that the DSP is relatively likely to accept, thus decreasing latency and avoiding the DSP getting overwhelmed with advertisement requests it has to filter, reducing unnecessary processing costs for the DSP handling the advertisement requests, and reducing infrastructure costs for operating the advertisement request allocation platform.

Another advantage of embodiments of the invention is that an optimum offer rate sends a number of advertisement requests that is most appropriate given past actions of that DSP. A further advantage of embodiments of the invention is that they periodically reevaluate the utilization rate, allowing the optimum offer rate to change in response to changing utilization behavior.

An advantage of the invention is that it can respond rapidly to changes in buying behavior, thus quickly sending more requests when buying starts and not sending unwanted requests when buying stops, due to the minimal length of the candidate time windows, all in order to achieve an accurate utilization rate.

A still other advantage of embodiments of the invention is that the use by the offer generator of a minimum offer rate a flow of offers from stopping when the utilization rate is low or zero. Were the optimum offer rate to reduce to zero, this could mean that an increase in advertisement request utilization which is desired by a DSP would not be identified, as there would be no offers available to accept. However, if offers are still being made, albeit at a low rate, an acceptance of such offers may be detected and the optimum offer rate may be adapted to respond thereto. For example, the optimum offer rate may increase from the minimum in response to an increase in advertisement request utilization until either the optimum offer rate is appropriate for the required advertisement request, or until all advertisement requests has been sent to the DSP.

A yet further advantage of embodiments of the invention is that embodiments of the invention act as one or more of a smart filter and a smart regulator, ensuring that the right advertisement requests reach the right DSPs at the right time, enhancing one or more of the overall efficiency and the effectiveness of the programmatic advertising ecosystem.

Any logic or application described herein that comprises software or code can be embodied in any non-transitory machine-readable or computer-readable medium for use by or in connection with an instruction execution system (e.g. one or more processors) in a computer system or other system. In this sense, the logic may comprise, for example, statements including instructions and declarations that can be fetched from the computer-readable medium and can be executed by the instruction execution system. In the context of the present disclosure, a machine-readable medium or computer-readable medium can be any medium that can contain, store, or update the logic or application described herein for use by or in connection with the instruction execution system. For example, the machine-readable medium or computer-readable medium may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The Appendix contains pseudocode for the method to update an exposed group comprising end users that have seen a winning advertisement and to update a control group with control group members having similar statistical properties to members of the exposed group except that the control group members have not seen the winning advertisement.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the advertisement request allocation platform.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the advertisement request allocation platform. It is intended, therefore, that the subject matter in the above description shall be interpreted as illustrative and shall not be interpreted in a limiting sense.

### APPENDIX

Following is pseudocode for the method of determining an optimum offer rate at which to send an advertisement request to a demand-side platform (DSP) and for the advertisement request allocation platform.

```
aggregate available_requests, requests and impressions into buckets of
length t minutes
cumulative_available_requests = 0
cumulative_requests = 0
cumulative_impressions = 0
min_first_adjusted_rate = 1e32
max_second_adjusted_rate = −1e32
min_first_adjusted_rate_time = −1
max_second_adjusted_rate_time = −1
#each iteration is for one candidate time window
for each bucket i in descending time order{
  cumulative_available_requests += available_requests in bucket[i]
  cumulative_requests += requests in bucket[i]
  cumulative_impressions += impressions in bucket[i]
  #calculate candidate utilization rate
  candidate_util_rate[i] = cumulative_impressions / cumulative_requests
  #calculate the measure of variance (in this case standard error)
  candidate_std_err = sqrt(candidate_util_rate * (1 −
candidate_util_rate) / cumulative_requests)
  first_adjusted_rate = candidate_util_rate + candidate_std_err
  second_adjusted_rate = candidate_util_rate − candidate_std_err
  #update min_first_adjusted_rate
  if first_adjusted_rate < min_first_adjusted_rate{
  min_first_adjusted_rate = first_adjusted_rate
  min_first_adjusted_rate_time = i
  }
  #update max_second_adjusted_rate
  if second_adjusted_rate > max_second_adjusted_rate{
  max_second_adjusted_rate = second_adjusted_rate
  max_second_adjusted_rate_time = i
  }
}
first_finalist_time_window = min_first_adjusted_rate_time
second_finalist_time_window = max_second_adjusted_rate_time
if first_finalist_time_window < second_finalist_time_window{
  finalist_time_window = first_finalist_time_window
}else{
  finalist_time_window = second_finalist_time_window
}
utilization_rate = candidate_util_rate[finalist_time_window]
```

1. An advertisement request allocation platform comprising:
a monitoring module comprising an offer rate builder, the offer rate builder configured to periodically determine a utilization rate using a plurality of candidate time windows, wherein the utilization rate for a combination of a group of advertisement requests and a demand-side platform (DSP) comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP, wherein the offer rate builder is further configured to determine the utilization rate by:
determining (i) a utilization rate and (ii) a measure of variability of the utilization rate for a plurality of candidate time windows;
determining, for one or more of the plurality of candidate time windows, a first adjusted rate, wherein the first adjusted rate comprises the utilization rate plus the measure of variability for that candidate time window;
determining, for one or more of the plurality of candidate time windows, a second adjusted rate, wherein the second adjusted rate comprises the utilization rate minus the measure of variability for that candidate time window;
identifying a first finalist time window from the plurality of candidate time windows, wherein the first finalist time window is the candidate time window for which the first adjusted rate is at a minimum;
identifying a second finalist time window from the plurality of candidate time windows, wherein the second finalist time window is the candidate time window for which the second adjusted rate is at a maximum;
selecting the shorter of the first finalist time window and the second finalist time window as the selected time window;
determining the utilization rate for the selected time window as the utilization rate for the combination;
determining the optimum offer rate at which to send the advertisement request to the DSP; and
sending advertisement requests to the DSP using the optimum offer rate.

2. The advertisement request allocation platform of claim 1, wherein the candidate time windows comprise a plurality of time windows having a common end time and different start times.

3. The advertisement request allocation platform of claim 1, wherein the offer module further comprises an auction module, wherein the auction module is configured to receive an advertisement request in an auction from the DSP, wherein the offer module is further configured to send the advertisement request to the DSP, wherein the auction module is further configured to receive the optimum offer rate from the offer rate builder, wherein the auction module is further configured to use the optimum offer rate when sending the advertisement request to the DSP.

4. The advertisement request allocation platform of claim 3, wherein the auction module is further configured to send the advertisement request at a minimum offer rate when the utilization rate is below a minimum threshold.

5. The advertisement request allocation platform of claim 3, wherein the auction module is further configured to send the advertisement request at a maximum offer rate when the utilization rate is above a maximum threshold.

6. The advertisement request allocation platform of claim 3, wherein the auction module is further configured to send the advertisement request at a determined offer rate that is proportional to the utilization rate.

7. The advertisement request allocation platform of claim 1, wherein the offer rate builder determines the optimum offer rate to be the higher of (i) a predetermined minimum offer rate and (ii) a determined offer rate determined based on the utilization rate and the available advertisement requests.

8. The advertisement request allocation platform of claim 1, wherein the offer rate builder determines the utilization rate by dividing a number of advertisement requests utilized by a number of advertisement requests sent to the DSP.

9. The advertisement request allocation platform of claim 7, wherein the offer rate builder determines the optimum offer rate by determining the higher of (i) the predetermined minimum offer rate and (ii) the determined offer rate that the offer rate builder computes using the equation:
$$determined offer\_rate = \frac{utilization rate * offers\_sent * n}{available requests}$$
wherein the utilization rate comprises the number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send.

10. The advertisement request allocation platform of claim 1, wherein the advertisement request parameter comprises one or more of a mobile app that originates the advertisement request for an end user that is viewing a part of the mobile app reserved for display of an advertisement, a webpage that originates the advertisement request for the end user that is viewing the webpage reserved for display of an advertisement, a format of the advertisement comprised in the advertisement request, a supply-side platform (SSP) that sent the advertisement request to the DSP, a country of origin of the advertisement request, an auction type of a real-time auction running on the SSP, an end user device type for an end user device controlled by the end user, an advertisement type, an advertisement publisher, an identifier of the SSP, a location of the end user device, and another advertisement request parameter.

11. The advertisement request allocation platform of claim 1, wherein the offer rate builder determines the first adjusted rate for each of the plurality of candidate time windows.

12. The advertisement request allocation platform of claim 1, wherein the offer rate builder determines the second adjusted rate for each of the plurality of candidate time windows.

13. The advertisement request allocation platform of claim 1, wherein a set of candidate time windows (CWs) comprises:
$${CW}_{1} = ( {T}_{end} - 1 minute ) to {T}_{end}$$
$${CW}_{2} = ( {T}_{end} - 2 minutes ) to {T}_{end}$$
$$…$$
$${CW}_{N} = ( {T}_{end} - N minutes ) to {T}_{end} ,$$
where T_{end} comprises the common end time.

14. The advertisement request allocation platform of claim 1, wherein the advertisement request comprises advertisement request data.

15. The advertisement request allocation platform of claim 14, wherein the advertisement request data comprises end user data.

16. The advertisement request allocation platform of claim 15, wherein the end user data comprises one or more of end user personal data, end user device data, contextual data, advertisement spot data, website data, mobile app data, network data, and privacy data.

17. The advertisement request allocation platform of claim 3, wherein when the utilization rate is less than a first threshold, the auction module is further configured to send the advertisement request at a minimum offer rate.

18. The advertisement request allocation platform of claim 17, wherein when the utilization rate is more than a second threshold, the auction module is further configured to send the advertisement request at a maximum offer rate.

19. The advertisement request allocation platform of claim 18, wherein for a utilization rate between the first threshold and the second threshold, the auction module is further configured to send the advertisement request at a determined offer rate that is proportional to the utilization rate.

20. The advertisement request allocation platform of claim 3, wherein the auction module is further configured to receive from the DSP a desired engagement rate.

21. The advertisement request allocation platform of claim 20, wherein the desired engagement rate comprises a desired number of advertisement requests per advertisement utilized by the DSP.

22. The advertisement request allocation platform of claim 4, wherein the auction module is further configured to receive from the DSP the minimum threshold.

23. The advertisement request allocation platform of claim 8, wherein the offer module further comprises an advertisement request interface, the advertisement request interface operably connected to the end user, the advertisement request interface also operably connected to the auction module, wherein the advertisement request interface is configured to receive the advertisement request from the end user, wherein the advertisement request interface is further configured to identify a winning advertisement request, wherein the advertisement request interface is further configured to send the winning advertisement to the end user that sent the advertisement request.

24. The advertisement request allocation platform of claim 23, wherein the advertisement request interface receives a notification of utilization of the advertisement from the end user.

25. The advertisement request allocation platform of claim 23, wherein the offer module further comprises an offer generator, the offer generator operably connected to the advertisement request interface, wherein the offer generator is configured to receive an advertisement request from the advertisement request interface.

26. The advertisement request allocation platform of claim 25, wherein the offer generator is configured to determine the group to which the advertisement request belongs.

27. The advertisement request allocation platform of claim 26, wherein the offer generator is configured to determine the group using the advertisement request data comprised in the advertisement request.

28. The advertisement request allocation platform of claim 25, wherein the auction module sends the advertisement request to all DSPs to which the offer generator determines that the advertisement request should be sent.

29. The advertisement request allocation platform of claim 25, wherein the offer module further comprises a logging module, the logging module operably connected to the advertisement request interface, the logging module configured to log the advertisement request.

30. The advertisement request allocation platform of claim 29, wherein the monitoring module further comprises storage, the storage operably connected to the offer generator, the storage further operably connected to the logging module, the storage further operably connected to the offer rate builder, wherein the storage is configured to store one or more of the advertisement request and advertisement utilization data.

31. The advertisement request allocation platform of claim 30, wherein the storage comprises stored optimum offer rates for combinations of the group and the DSP.

32. The advertisement request allocation platform of claim 31, wherein the offer generator retrieves the stored optimum offer rate for at least one combination.

33. The advertisement request allocation platform of claim 32, wherein, using the retrieved optimum offer rate, for at least one DSP, the offer generator makes a determination whether to send the advertisement request to the DSP.

34. The advertisement request allocation platform of claim 33, wherein the offer generator sends the determination to the advertisement request interface.

35. The advertisement request allocation platform of claim 33, wherein the offer generator is configured to send the advertisement request at a minimum offer rate when the utilization rate is below a minimum threshold.

36. An advertisement request allocation platform comprising:
a monitoring module comprising an offer rate builder, the offer rate builder configured to periodically determine a utilization rate using a plurality of candidate time windows, wherein the utilization rate for a combination of a group of advertisement requests and a demand-side platform (DSP) comprises a rate at which the DSP utilizes the group, wherein the group comprises advertisement requests sharing one or more advertisement request parameters, the offer rate builder further configured to periodically determine for the combination a measure of variability of the utilization rate, wherein the offer rate builder determines the optimum offer rate to be the higher of (i) a predetermined minimum offer rate and (ii) a determined offer rate determined based on the utilization rate and the available advertisement requests, using the equation:
$$determined offer\_rate = \frac{utilization rate * offers\_sent * n}{available requests}$$
wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send; and
an offer module operably connected to the DSP, the offer module configured to send the advertisement request to the DSP, wherein the offer rate builder is further configured to determine for the combination an optimum offer rate at which to send the advertisement request to the DSP, wherein the offer module further comprises an auction module, wherein the auction module is configured to receive an advertisement request in an auction from the DSP, wherein the offer module is further configured to send the advertisement request to all DSPs to which the offer generator determines that the advertisement request should be sent, wherein the auction module is further configured to receive the optimum offer rate from the offer rate builder, wherein the auction module is further configured to use the optimum offer rate when sending the advertisement request to the DSP, wherein when the utilization rate is less than a first threshold, the auction module is further configured to send the advertisement request at a minimum offer rate, wherein when the utilization rate is more than a second threshold, the auction module is further configured to send the advertisement request at a maximum offer rate, wherein for a utilization rate between the first threshold and the second threshold, the auction module is further configured to send the advertisement request at a determined offer rate that is proportional to the utilization rate wherein the auction module is further configured to send the advertisement request at a minimum offer rate when the utilization rate is below a minimum threshold, wherein the auction module is further configured to send the advertisement request at a maximum offer rate when the utilization rate is above a maximum threshold, wherein the auction module is further configured to send the advertisement request at a determined offer rate that is proportional to the utilization rate, wherein the auction module is further configured to receive from the DSP a desired engagement rate, wherein the desired engagement rate comprises a desired number of advertisement requests per advertisement utilized by the DSP, wherein the offer module further comprises an advertisement request interface, the advertisement request interface operably connected to the end user, the advertisement request interface also operably connected to the auction module, wherein the advertisement request interface is configured to receive the advertisement request from the end user, wherein the advertisement request interface is further configured to identify a winning advertisement request, wherein the advertisement request interface is further configured to send the winning advertisement to the end user that sent the advertisement request, wherein the advertisement request interface receives a notification of utilization of the advertisement from the end user, wherein the offer module further comprises an offer generator, the offer generator operably connected to the advertisement request interface, wherein the offer generator is configured to receive an advertisement request from the advertisement request interface, wherein the offer generator is configured to determine the group to which the advertisement request belongs, wherein the offer module further comprises a logging module, the logging module operably connected to the advertisement request interface, the logging module configured to log the advertisement request, wherein the monitoring module further comprises storage, the storage operably connected to the offer generator, the storage further operably connected to the logging module, the storage further operably connected to the offer rate builder, wherein the storage is configured to store one or more of the advertisement request and advertisement utilization data, wherein the storage comprises stored optimum offer rates for combinations of the group and the DSP, wherein the offer generator retrieves the stored optimum offer rate for at least one combination, wherein, using the retrieved optimum offer rate, for at least one DSP, the offer generator makes a determination whether to send the advertisement request to the DSP, wherein the offer generator sends the determination to the advertisement request interface, wherein the offer generator is configured to send the advertisement request at a minimum offer rate when the utilization rate is below a minimum threshold,
wherein the offer rate builder is further configured to determine the utilization rate by:
determining (i) a utilization rate and (ii) a measure of variability of the utilization rate for a plurality of candidate time windows, wherein the candidate time windows comprise a plurality of time windows having a common end time and different start times;
determining, for one or more of the plurality of candidate time windows, a first adjusted rate, wherein the first adjusted rate comprises the utilization rate plus the measure of variability for that candidate time window;
determining, for one or more of the plurality of candidate time windows, a second adjusted rate, wherein the second adjusted rate comprises the utilization rate minus the measure of variability for that candidate time window;
identifying a first finalist time window from the plurality of candidate time windows, wherein the first finalist time window is the candidate time window for which the first adjusted rate is at a minimum;
identifying a second finalist time window from the plurality of candidate time windows, wherein the second finalist time window is the candidate time window for which the second adjusted rate is at a maximum;
selecting the shorter of the first finalist time window and the second finalist time window as the selected time window;
determining the utilization rate for the selected time window as the utilization rate for the combination;
determining the optimum offer rate at which to send the advertisement request to the DSP; and
sending advertisement requests to the DSP using the optimum offer rate.

37. A method of determining an optimum offer rate at which to send an advertisement request to a demand-side platform (DSP) comprising, by an advertisement request allocation platform comprising a monitoring module comprising an offer rate builder, the offer rate builder configured to periodically determine a utilization rate using a plurality of candidate time windows, wherein the utilization rate for a combination of a group of advertisement requests and a DSP comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP:
determining (i) a utilization rate and (ii) a measure of variability of the utilization rate for a plurality of candidate time windows;
determining, for one or more of the plurality of candidate time windows, a first adjusted rate, wherein the first adjusted rate comprises the utilization rate plus the measure of variability for that candidate time window;
determining, for one or more of the plurality of candidate time windows, a second adjusted rate, wherein the second adjusted rate comprises the utilization rate minus the measure of variability for that candidate time window;
identifying a first finalist time window from the plurality of candidate time windows, wherein the first finalist time window is the candidate time window for which the first adjusted rate is at a minimum;
identifying a second finalist time window from the plurality of candidate time windows, wherein the second finalist time window is the candidate time window for which the second adjusted rate is at a maximum;
selecting the shorter of the first finalist time window and the second finalist time window as the selected time window;
determining the utilization rate for the selected time window as the utilization rate for the combination;
determining the optimum offer rate at which to send the advertisement request to the DSP; and
sending advertisement requests to the DSP using the optimum offer rate.

38. The method of claim 37, wherein the candidate time windows comprise a plurality of time windows having a common end time and different start times.

39. The method of claim 37, wherein the sending step further comprises sending the advertisement request at a minimum offer rate when the utilization rate is below a first threshold.

40. The method of claim 39, wherein the sending step further comprises sending the advertisement request at a maximum offer rate when the utilization rate is above a second threshold.

41. The method of claim 40, wherein for a utilization rate between the first threshold and the second threshold, the sending step further comprises sending the advertisement request at a determined offer rate that is proportional to the utilization rate.

42. The method of claim 41, wherein the sending step further comprises sending the advertisement requests at a determined offer rate that is proportional to the utilization rate.

43. The method of claim 37, wherein the method further comprises determining the optimum offer rate to be the higher of (i) a predetermined minimum offer rate and (ii) a determined offer rate determined based on the utilization rate and the available advertisement requests.

44. The method of claim 37, wherein the step of determining the utilization rate comprises dividing a number of advertisement requests utilized by a number of advertisement requests sent to the DSP.

45. The method of claim 43, wherein the step of determining the determined offer rate comprises computing the determined offer rate using the equation:
$$determined offer\_rate = \frac{utilization rate * offers\_sent * n}{available requests}$$
wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send.

46. The method of claim 37, wherein a set of candidate time windows (CWs) comprises:
$${CW}_{1} = ( {T}_{end} - 1 minute ) to {T}_{end}$$
$${CW}_{2} = ( {T}_{end} - 2 minutes ) to {T}_{end}$$
$$…$$
$${CW}_{N} = ( {T}_{end} - N minutes ) to {T}_{end} ,$$
where T_{end} comprises the common end time.

47. The method of claim 37, further comprising receiving a notification of utilization of the advertisement from the end user.

48. The method of claim 37, wherein the sending step comprises sending the advertisement request at a minimum offer rate when the utilization rate is below a minimum threshold.

49. A method of determining an optimum offer rate at which to send an advertisement request to a demand-side platform (DSP) comprising, by an advertisement request allocation platform comprising a monitoring module comprising an offer rate builder, the offer rate builder configured to periodically determine a utilization rate using a plurality of candidate time windows, wherein the candidate time windows comprise a plurality of time windows having a common end time and different start times, wherein the utilization rate for a combination of a group of advertisement requests and a DSP comprises a rate at which the DSP utilizes the group, wherein the group comprises advertisement requests sharing one or more advertisement request parameters, the offer rate builder further configured to periodically determine for the combination a measure of variability of the utilization rate; and an offer module operably connected to the DSP, the offer module configured to send the advertisement request to the DSP, wherein the offer rate builder is further configured to determine for the combination an optimum offer rate at which to send the advertisement request to the DSP:
determining (i) a utilization rate and (ii) a measure of variability of the utilization rate for a plurality of candidate time windows;
determining, for one or more of the plurality of candidate time windows, a first adjusted rate, wherein the first adjusted rate comprises the utilization rate plus the measure of variability for that candidate time window;
determining, for one or more of the plurality of candidate time windows, a second adjusted rate, wherein the second adjusted rate comprises the utilization rate minus the measure of variability for that candidate time window;
identifying a first finalist time window from the plurality of candidate time windows, wherein the first finalist time window is the candidate time window for which the first adjusted rate is at a minimum;
identifying a second finalist time window from the plurality of candidate time windows, wherein the second finalist time window is the candidate time window for which the second adjusted rate is at a maximum;
selecting the shorter of the first finalist time window and the second finalist time window as the selected time window;
determining the utilization rate for the selected time window as the utilization rate for the combination by dividing a number of advertisement requests utilized by a number of advertisement requests sent to the DSP;
determining the optimum offer rate at which to send the advertisement request to the DSP;
sending advertisement requests to the DSP using the optimum offer rate, wherein the sending step comprises sending the advertisement request at a minimum offer rate when the utilization rate is below a first threshold, wherein the sending step further comprises sending the advertisement request at a maximum offer rate when the utilization rate is above a second threshold, wherein for a utilization rate between the first threshold and the second threshold, the sending step further comprises sending the advertisement request at a determined offer rate that is proportional to the utilization rate, wherein the method further comprises determining the optimum offer rate to be the higher of (i) a predetermined minimum offer rate and (ii) a determined offer rate determined based on the utilization rate and the available advertisement requests, wherein the method further comprises computing the determined offer rate using the equation:
$$determined offer\_rate = \frac{utilization rate * offers\_sent * n}{available requests}$$
wherein the utilization rate comprises a number of advertisement requests utilized by the DSP in a selected time window divided by a number of advertisement requests sent to the DSP during the selected time window, offers_sent comprises the number of offers sent in the selected candidate time window, n comprises a desired number of advertisement requests per advertisement utilized by the DSP, and available requests comprises the number of advertisement requests that were available for the advertisement request allocation platform to send, wherein the sending step comprises sending the advertisement request at a minimum offer rate when the utilization rate is below a minimum threshold; and
receiving a notification of utilization of the advertisement from the end user.
